(19) United States
(12) Patent Application Publication
(10) Pub. No.: US 2020/0055279 A1
(43) Pub. Date: Feb. 20, 2020

(54) Polymer and Metal Foil Laminates

(71) Applicant: Celanese EVA Performance Polymers Corporation, Irving, TX (US)

(72) Inventors: Jeffrey Haley, Norwood, OH (US); Robert Scott Weber, Liberty Township, OH (US)

(21) Appl. No.: 16/545,411

(22) Filed: Aug. 20, 2019

Related U.S. Application Data
(60) Provisional application No. 62/719,913, filed on Aug. 20, 2018.

(51) Int. Cl. B32B 15/085; B32B 33/00

(52) U.S. Cl. CPC B32B 15/085; B32B 33/00; B32B 2323/043; B32B 2331/04; B32B 2323/10; B32B 2311/12; B32B 2311/24; B32B 2323/046

(57) ABSTRACT

A multi-layer film or laminate is disclosed in which an olefinic polymer layer is adhered to a metal foil layer without the use of an adhesive. The olefinic polymer layer contains an olefinic polymer in combination with a transition metal salt. The addition of the transition metal salt greatly improves the peel strength of the laminate.

### RELATED APPLICATIONS

The present application is based upon and claims priority to U.S. Provisional Patent Application Ser. No. 62/719,913, having a filing date of Aug. 20, 2018, which is incorporated herein by reference.

### BACKGROUND

Multi-layer films are widely used in packaging applications. For instance, the multi-layer films are used to produce flexible packaging and are used to seal rigid and semi-rigid packaging. Multi-layer films are made from layers of different materials with each material bringing various properties to the finished package. For example, some layers are incorporated into the composite structure in order to provide barrier properties to moisture, oxygen and other gases. For example, metal foil layers have been conventionally incorporated into multi-layer films due to their barrier characteristics. Such barrier layers, for instance, protect the product within the packaging and can greatly increase shelf life.

In addition to barrier layers, multi-layer films also contain various other layers that are needed for the film to be incorporated into a package. The other layers, for instance, can be designed to seal to other materials for forming a sealed package. For instance, the other layers can bond to other materials on the package and/or can provide improved mechanical properties.

Within the packaging industry, there are a variety of methods used to produce films. The method used to produce a film can depend on the needs of the package, the materials being combined together, and the type of product being loaded into the package. In many cases, different polymer layers are coextruded together in forming a composite film. Polymer layers, however, cannot be simply coextruded with metallic layers. For instance, when incorporating a metal layer into a composite film, polymer layers are typically applied to the metal layer via extrusion coating, extrusion lamination, or thermal lamination.

One problem that has been experienced is the ability to form a strong bond between a polymer layer and a metal foil, such as an aluminum foil. Bonding polymer layers to metal foils, for instance, can be challenging during extrusion coating, extrusion lamination and thermal lamination. For example, polyolefin polymers, such as polyethylene, are known to bond poorly to metal foils and films. Polyolefin polymers, however, are well suited for use in packaging films due to their physical and chemical properties.

In the past, in order to improve bond strength between polymer films and metal foils, various additives have been incorporated into the polymer. For example, the polymer layer may be combined with ionomers and other additives that can not only significantly increase the cost of producing the polymer layer but can also require the use of extra processing steps, such as priming of the metal foil surface.

In view of the above, a need exists for an improved multi-layer film that has increased bond strength between a polyolefin layer and a metal foil. A need also exists for a process for producing the laminate.

### SUMMARY

The present disclosure is generally directed to a laminate containing a metal foil layer and to packaging products incorporating the laminate.

In one embodiment, the present disclosure is directed to a laminate comprising a first layer made from a metal foil. The metal foil can generally have a thickness of greater than about 5 microns to less than about 65 microns. Adhered to one surface of the metal foil is a second layer made from a polymer composition. The second layer comprises at least one olefinic polymer in an amount of at least about 50% by weight of the second layer. The at least one olefinic polymer is combined with a transition metal salt in an amount from about 10 to about 1000 parts per million based on the weight of the olefinic polymers present in the second layer. The second layer can be directly adhered to the surface of the metal foil. For instance, the second layer can be adhered to the first surface of the metal foil without the use of an adhesive. The second layer can have a peel strength to the surface of the metal foil in an amount greater than about 100 gf/in, such as in an amount greater than about 150 gf/in. In one embodiment, the peel strength is greater than about 800 gf/in.

In accordance with another embodiment of the present disclosure, a package is disclosed that includes an interior hollow enclosure surrounded by at least one panel. The panel can be made from the laminate as described above. For example, in one embodiment, the entire package can be made from the laminate by attaching one or more panels together. In an alternative embodiment, the package may comprise a blister package. The blister package can include at least one dome member that defines the hollow enclosure. The dome member can be attached to the laminate as described above.

In still another embodiment, the laminate of the present disclosure can be used to produce outdoor panels.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a schematic illustration of one embodiment of a method that may be employed to form laminates of the present disclosure;

FIG. 2 is a cross-sectional view of one embodiment of a laminate made in accordance with the present disclosure;

FIG. 3 is a cross-sectional view of one embodiment of a flexible package made in accordance with the present disclosure;

FIG. 4 is a perspective view of one embodiment of blister packages made in accordance with the present disclosure; and

FIG. 5 is a cross-sectional view of the blister package illustrated in FIG. 4.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a multi-layer film or laminate containing an olefinic polymer layer directly adhered to the surface of a metal foil. The multi-layer film or laminate of the present disclosure can be used in all different types of applications. For instance, the composite film is particularly well suited for producing various packaging configurations. For example, laminates made in accordance with the present disclosure can be used to produce flexible packaging. In addition, the laminate can be used as a lid in various rigid or semi-rigid applications, can be used to close and seal blister packages, or can be used to produce various other different types of packages. In addition, the laminate is particularly well suited for constructing outdoor panels.

In one embodiment, the olefinic polymer layer is melt extruded directly onto a surface of the metal foil. In accordance with the present disclosure, the olefinic layer is made from a polymer composition that can directly bond to the metallic surface without the use of adhesives or any type of tie layer. In accordance with the present disclosure, the polymer composition contains an olefinic polymer combined with a transition metal salt. The transition metal salt has been found to dramatically improve the ability of the polymer layer to bond to the metal foil.

For example, the median peel strength between the polymer layer and the metal foil can be greater than about 100 gf/in as determined using a 90° T-Peel test in accordance with ASTM D1876-08 (2015). For example, the median peel strength can be greater than about 150 gf/in, such as greater than about 200 gf/in, such as greater than about 300 gf/in, such as greater than about 400 gf/in, such as greater than about 500 gf/in, such a greater than about 600 gf/in, such as greater than about 700 gf/in, such as greater than about 800 gf/in, such as greater than about 900 gf/in. The median peel strength between the polymer layer and the metal foil can depend upon the olefinic polymers contained within the polymer layer, the type of metal used to construct the metal foil, and various other factors. In general, the peel strength is less than about 5000 gf/in, such as less than about 4000 gf/in, such as less than about 3000 gf/in. When the polymer layer contains ethylene vinyl acetate in an amount greater than 50% by weight, for instance, the median peel strength can generally be from about 400 gf/in to about 5000 gf/in, such as greater than 800 gf/in to about 3000 gf/in. When the polymer layer contains polyethylene, such as a low density polyethylene, in an amount greater than about 50% by weight, the median peel strength can be generally greater than about 100 gf/in, such as greater than about 150 gf/in, such as greater than about 200 gf/in and generally less than about 1000 gf/in.

Various embodiments of the present invention will now be described in further detail.

### I. Polymer Composition

As noted above, the polymer composition of the present invention may contain at least one olefinic polymer and at least one transition metal salt. The amount of the transition metal salts is typically controlled so that the polymer composition can achieve a desired degree of oxidation and/or adherence to metals, but not so high so as to adversely impact the properties and processability of the resulting composition. For instance, transition metal salts typically constitute from about 10 to about 1,000 parts per million, in some embodiments from about 20 to about 500 parts per million, and in some embodiments, from about 30 to about 200 parts per million, based on the weight of olefinic polymers in the composition. In certain embodiments, transition metal salts may constitute from about 10 to about 1,000 parts per million, in some embodiments from about 20 to about 500 parts per million, and in some embodiments, from about 30 to about 200 parts per million of the entire polymer composition. Likewise, olefinic polymers typically constitute at least about 50 wt. %, in some embodiments from about 60 wt. % to about 99.999 wt. %, in some embodiments from about 80 wt. % to about 99.5 wt. %, and in some embodiments, from about 90 wt. % to about 99.5 wt. % of the polymer composition. Regardless of the relative concentration of each component, the melt flow index of the resulting composition typically ranges range from about 0.5 to about 50 grams per 10 minutes (“g/10 min”), in some embodiments from about 1 to about 40 g/10 min, in some embodiments from about 5 to about 30 g/10 min, and in some embodiments, from about 12 to about 25 g/10 min, as determined in accordance with ASTM D1238-13 at a temperature of 190° C. and a load of 2.16 kilograms. The melting point may also range from about 60° C. to about 120° C., and in some embodiments, from about 65° C. to about 115° C., as determined in accordance with ASTM D3418-12e1.

As described above, in one embodiment, the polymer composition can be formulated so as to have a relatively high oxidation rate. The oxidation rate of the composition can be characterized by the heat flow profile of the composition while being exposed to oxygen using differential scanning calorimetry (“DSC”) in accordance with ASTM D3895-14. More particularly, the fast oxidizing polymer composition of the present invention may exhibit a heat flow of about 0.7 watts per gram (“W/g”) or more, in some embodiments about 0.8 W/g or more, and in some embodiments, from about 0.85 to about 1.5 W/g after being exposed to an oxygen atmosphere at a temperature of 180° C. The onset of heat flow can be achieved within a time period of about 100 minutes or less, in some embodiments about 60 minutes or less, in some embodiments about 20 minutes or less, in some embodiments about 2 minutes or less, in some embodiments about 1 minute or less, and in some embodiments, from about 1 second to about 50 seconds. In certain embodiments, for instance, the composition may exhibit a heat flow of 0.15 W/g after being exposed to an oxygen atmosphere at a temperature of 180° C. for about 1.5 minutes or less, in some embodiments about 1 minute or less, and in some embodiments, from 1 second to about 50 seconds.

### A. Olefinic Polymer

A wide variety of olefin polymers may generally be employed in the polymer composition, such as ethylene polymers (e.g., low density polyethylene (“LDPE”), high density polyethylene (“HDPE”), linear low density polyethylene (“LLDPE”), etc.), propylene homopolymers (e.g., syndiotactic, atactic, isotactic, etc.), propylene copolymers, olefin-diene copolymers, ethylene vinyl acetate copolymers, ethylene (meth)acrylic acid polymers (e.g., ethylene acrylic acid copolymers and partially neutralized ionomers of these copolymers, ethylene methacrylic acid copolymers and partially neutralized ionomers of these copolymers, etc.), ethylene (meth)acrylate polymers (e.g., ethylene methylacrylate copolymers, ethylene ethyl acrylate copolymers, ethylene butyl acrylate copolymers, etc.), and so forth. In one particular embodiment, for example, the polymer composition may contain an ethylene vinyl acetate polymer, which is defined as a copolymer that contains at least one ethylene monomer and at least one vinyl acetate monomer. When employed, the present inventors have discovered that certain aspects of the ethylene vinyl acetate polymer can also be selectively controlled to help achieve the desired oxidative properties. For instance, the ethylene vinyl acetate polymer may be selectively controlled so that it has a vinyl acetate content of from about 5 wt. % to about 35 wt. %, in some embodiments about 10 wt. % to about 30 wt. %, and in some embodiments, from about 12 wt. % to about 25 wt. %. The density of the ethylene vinyl acetate polymer may also range from about 0.900 to about 1.00 gram per cubic centimeter (g/cm³), in some embodiments from about 0.910 to about 0.980 g/cm³, and in some embodiments, from about 0.930 to about 0.960 g/cm³, as determined in accordance with ASTM D1505-10. Still further, the melt flow index of the ethylene vinyl acetate polymer may range from about 0.1 to about 70 g/10 min, in some embodiments from about 0.5 to about 50 g/10 min, and in some embodiments, from about 1 to about 35 g/10 min, as determined in accordance with ASTM D1238-13 at a temperature of 190° C. and a load of 2.16 kilograms. The melting point may also range from about 60° C. to about 120° C., and in some embodiments, from about 75° C. to about 100° C., as determined in accordance with ASTM D3418-12e1. Examples of suitable ethylene vinyl acetate polymers that may be employed include those available from Celanese under the designation ATEVA® (e.g., ATEVA® 1609, 1813, or 2821A); DuPont under the designation ELVAX® (e.g., ELVAX® 470); and Arkema under the designation EVATANE® (e.g., EVATANE 20-20).

Any of a variety of techniques may generally be used to form the ethylene vinyl acetate polymer with the desired properties as is known in the art. In one embodiment, the polymer is produced by copolymerizing an ethylene monomer and a vinyl acetate monomer in a high pressure reaction. Vinyl acetate may be produced from the oxidation of butane to yield acetic anhydride and acetaldehyde, which can react together to form ethylidene diacetate. Ethylidene diacetate can then be thermally decomposed in the presence of an acid catalyst to form the vinyl acetate monomer. Examples of suitable acid catalysts include aromatic sulfonic acids (e.g., benzene sulfonic acid, toluene sulfonic acid, ethylbenzene sulfonic acid, xylene sulfonic acid, and naphthalene sulfonic acid), sulfuric acid, and alkanesulfonic acids, such as described in U.S. Pat. No. 2,425,389 to Oxley et al.; U.S. Pat. No. 2,859,241 to Schnizer; and U.S. Pat. No. 4,843,170 to Isshiki et al. The vinyl acetate monomer can also be produced by reacting acetic anhydride with hydrogen in the presence of a catalyst instead of acetaldehyde. This process converts vinyl acetate directly from acetic anhydride and hydrogen without the need to produce ethylidene diacetate. In yet another embodiment, the vinyl acetate monomer can be produced from the reaction of acetaldehyde and a ketene in the presence of a suitable solid catalyst, such as a perfluorosulfonic acid resin or zeolite.

### B. Transition Metal Salt

As indicated above, the polymer composition of the present invention may also contain a transition metal salt. Without intending to be limited by theory, it is believed that the transition metal atom in the salt can accelerate free radical generation by hydroperoxides, which may be introduced along the polymer backbone during exposure to an oxidizing atmosphere (e.g., oxygen, air, etc.) at an elevated temperature, such as above about 150° C. (e.g., 180° C.). The transition metal cation employed in the salt may vary, but is typically a multi-valent transition metal (e.g., divalent or trivalent). U.S. Patent Application Publication No. 2017/0058101 discloses various different transition metal salts that may be used in accordance with the present disclosure. The '101 application is incorporated by reference herein.

Examples of such multi-valent transition metals may include, for instance, iron, manganese, nickel, copper, cobalt, vanadium, chromium, etc., as well as mixtures thereof. Iron may be particularly suitable. The anion of the salt may vary, such as a carboxylate, sulfonate, etc. In one embodiment, for instance, the anion is a carboxylate that is derived from a fatty acid. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. For instance, exemplary salts may include iron stearate, manganese stearate, nickel stearate, cobalt stearate, etc., as well as combinations thereof.

### C. Optional Additives

To maintain the desired properties, a substantial portion of the composition can sometimes be formed from olefin polymers and transition metal salts. That is, about 50 wt. % or more, in some embodiments from about 60 wt. % to about 99 wt. %, and in some embodiments, from about 70 wt. % to about 95 wt. % of the composition is formed by such components. Nevertheless, the composition may optionally contain one or more additives if so desired, such as flow aids, antimicrobials, fillers pigments, antioxidants, stabilizers, surfactants, waxes, solid solvents, flame retardants, anti-drip additives, and other materials added to enhance properties and processability. When employed, the optional additive(s) typically constitute from about 0.001 wt. % to about 50 wt. %, and in some embodiments, from about 0.01 wt. % to about 40 wt. %, and in some embodiments, from about 0.02 wt. % to about 30 wt. % of the composition.

In certain embodiments, for example, an antioxidant may be employed to help stabilize the melt flow properties of the composition. More particularly, reactions can sometimes occur between the olefinic polymer and transition metal, which results in an undesirable change in the melt flow index of the composition. The use of antioxidants can help to ameliorate this effect. For instance, sterically hindered phenolic antioxidant(s) may be employed in certain embodiments for this purpose. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-dioctadecyl ester (Irganox® 1093); 1,3,5-trimethyl-2,4,6-tris(3′,5′-di-tert-butyl-4′hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl] phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); tetrakis [methylene-(3,5-di-tertbutyl-4-hydroxycinnimate)]methane (Irganox® 1010); and ethylene-bis(oxyethylene)bis[3-(5-tert-butyl-4-hydroxy-m-tolyl)-propionate (Irganox® 245); and so forth.

The amount of the antioxidants can be selectively controlled to help achieve the desired improvement in flow properties without having an adverse impact on other properties of the composition, such as its ability to adhere to a substrate. In this regard, when employed, antioxidants typically constitute from about 10 to about 500 parts per million of the composition, in some embodiments from about 50 to about 450 parts per million of the composition, and in some embodiments, from about 100 to about 400 parts per million of the composition.

### II. Melt Blending

Generally speaking, the olefin polymer, transition metal salt, and other optional additives may be melt blended together to form the polymer composition. Melt blending may occur at a temperature range of from about 60° C. to about 260° C., in some embodiments, from about 80° C. to about 250° C., and in some embodiments, from about 100° C. to about 220° C. to form the polymer composition. Any of a variety of melt blending techniques may generally be employed in the present invention. For example, the components may be supplied separately or in combination to an extruder that includes at least one screw rotatably mounted and received within a barrel (e.g., cylindrical barrel). The extruder may be a single screw or twin screw extruder. For example, one embodiment of a single screw extruder may contain a housing or barrel and a screw rotatably driven on one end by a suitable drive (typically including a motor and gearbox). If desired, a twin-screw extruder may be employed that contains two separate screws. The configuration of the screw is not particularly critical to the present invention and it may contain any number and/or orientation of threads and channels as is known in the art. For example, the screw typically contains a thread that forms a generally helical channel radially extending around a core of the screw. A feed section and melt section may be defined along the length of the screw. The feed section is the input portion of the barrel where the ethylene vinyl acetate polymer and/or transition metal salt are added. The melt section is the phase change section in which the polymer is changed from a solid to a liquid. While there is no precisely defined delineation of these sections when the extruder is manufactured, it is well within the ordinary skill of those in this art to reliably identify the feed section and the melt section in which phase change from solid to liquid is occurring. Although not necessarily required, the extruder may also have a mixing section that is located adjacent to the output end of the barrel and downstream from the melting section. If desired, one or more distributive and/or dispersive mixing elements may be employed within the mixing and/or melting sections of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

If desired, the ratio of the length (“L”) to diameter (“D”) of the screw may be selected to achieve an optimum balance between throughput and blending of the components. The L/D value may, for instance, range from about 15 to about 50, in some embodiments from about 20 to about 45, and in some embodiments from about 25 to about 40. The length of the screw may, for instance, range from about 0.1 to about 5 meters, in some embodiments from about 0.4 to about 4 meters, and in some embodiments, from about 0.5 to about 2 meters. The diameter of the screw may likewise be from about 5 to about 150 millimeters, in some embodiments from about 10 to about 120 millimeters, and in some embodiments, from about 20 to about 80 millimeters. In addition to the length and diameter, other aspects of the extruder may also be selected to help achieve the desired degree of blending. For example, the speed of the screw may be selected to achieve the desired residence time, shear rate, melt processing temperature, etc. For example, the screw speed may range from about 10 to about 800 revolutions per minute (“rpm”), in some embodiments from about 20 to about 500 rpm, and in some embodiments, from about 30 to about 400 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

### III. Films

Regardless of its particular constituents, any of variety of different techniques may generally be used to form the composition into a film. Suitable film-forming techniques may include, for instance, extrusion casting, flat sheet die extrusion, blown film extrusion, tubular trapped bubble film processes, etc. The film may generally have a thickness of from about 0.1 micrometers to about 25 millimeters. Thin films may, for instance, have a thickness of from about 0.1 micrometers to about 0.5 millimeters, in some embodiments from about 0.5 to about 500 micrometers, in some embodiments from about 1 to about 200 micrometers, and in some embodiments, from about 1 to about 60 micrometers. Likewise, thick films (or sheets) may have a thickness of from about 0.5 millimeters to about 25 millimeters, in some embodiments from about 0.6 to about 20 millimeters, and in some embodiments, from about 1 to about 10 millimeters.

### IV. Multi-Layer Films and Laminates

The polymer composition as described above can be laminated to a metal layer, such as a metal foil, to form a composite structure.

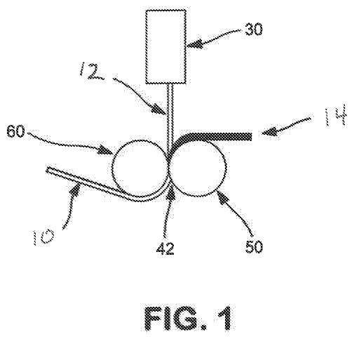

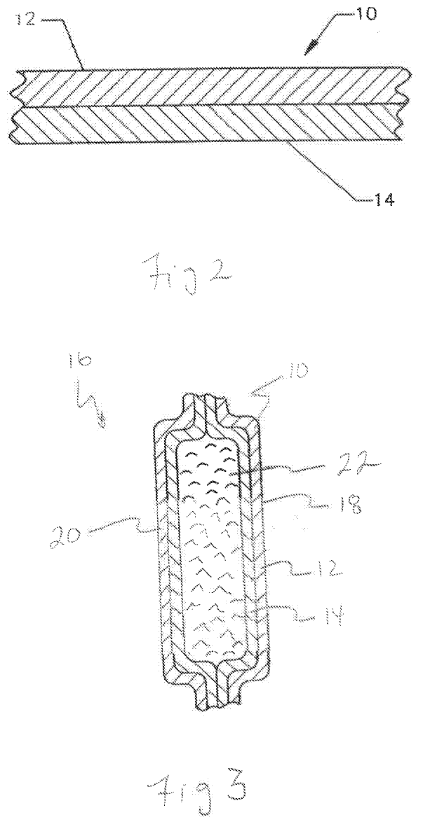

For example, referring to FIG. 2, in one embodiment, the resulting composite may have a two-layer structure. As shown in FIG. 1, the laminate 10 includes a first layer 12 laminated to a second layer 14. The first layer 12 can be made from the polymer composition of the present disclosure. The second layer 14, on the other hand, may comprise a metal foil layer.

In the embodiment illustrated in FIG. 2, the laminate 10 contains two layers. It should be understood, however, that laminates made in accordance with the present disclosure may contain more than two layers, such as three layers, four layers, five layers, six layers, seven layers, and so forth. For example, in one embodiment, another polymer layer may be laminated to the first polymer layer 12 opposite the metal foil 14. For example, the polymer composition of the present disclosure is not only well suited to bonding to metal foil layer 14 but is also capable of bonding to other materials. In still another embodiment, the metal foil layer 14 can be sandwiched inbetween two polymer film layers both made from the polymer composition of the present disclosure. In still other embodiments, the multi-layer composite may include a fibrous layer, such as a nonwoven or a paper web.

Various different types of metal foils can be incorporated into the multi-layer films or laminates made in accordance with the present disclosure. For instance, the metal foil can be made from various metals including aluminum and copper. In one embodiment, the metal foil has a thickness range that has been found to be particularly well suited for use in various packaging applications. For instance, the thickness of the metal foil can generally be greater than about 5 microns, such as greater than about 10 microns, such as greater than about 15 microns, such as greater than about 20 microns, such as greater than about 25 microns, such as greater than about 30 microns, such as greater than about 35 microns, such as greater than about 40 microns. The thickness of the metal foil can generally be less than about 100 microns, such as less than about 70 microns, such as less than about 60 microns, such as less than about 50 microns, such as less than about 40 microns. In one embodiment, a relatively thin metal foil was used having a thickness of from about 5 microns to about 30 microns. In an alternative embodiment, the metal foil can have a thickness of from about 35 microns to about 65 microns.

When employed, any of a variety of techniques may be employed to form a composite. In one embodiment, for example, the composite may be formed by extrusion coating the film onto the metal foil layer. One example of such an extrusion coating process in shown in FIG. 1. As illustrated, the polymer composition (e.g., in the form of pellets) may be initially supplied through an extruder (not shown) where the polymer composition is subjected to heat and pressure. The molten polymer composition is then forced by a screw (not shown) through a slit of an extrusion coating die 30. The slit may be straight line-shaped so that a molten film 12 is formed that is in the form of a thin sheet. The molten film 12 is thereafter drawn down into a nip 42 formed between a first roll 50 and a second roll 60. While the nature of these rolls may vary, in one embodiment, the first roll 50 may be a rubber-covered pressure roll and the second roll 60 may be a chill roll. Concurrently, a metal foil 14 is also supplied to the nip 42. Thus, at the nip 42, the molten film 12 is drawn down to the prescribed thickness or gauge and forced onto the metal foil 14 as both layers are traverse between the two rolls to form a laminate 10. The pressure at the nip may vary, but is typically from about 30 to about 120 pounds per linear inch. The resulting composite 10 may be subjected to any desired additional processing as is known in the art, such as slitting, cutting, stretching, heat treating, printing, etc. Furthermore, additional layers may be laminated to the composite 10 using techniques known in the art.

The melt-extruded laminates of the present invention may be employed in a wide variety of applications. For example, the composite may be used for packaging items, such as food products (e.g., snack packaging, heavy duty bags, grocery sacks, baked and frozen food packaging, frozen food, beverages, etc.), medical products, biological materials, electronic devices, garbage, and so forth.

For example, the laminate of the present disclosure can be used in all different types of packaging applications. Referring to FIG. 3, for instance, one embodiment of a flexible package 16 made in accordance with the present disclosure is shown. The package 16 defines a hollow enclosure for containing an item 22. The item 22, for instance, can comprise a solid, a liquid, or a paste. In one embodiment, for instance, the package 16 can be used to contain a food product, such as a beverage. Alternatively, the item 22 may comprise a condiment, such as ketchup or mayonnaise.

In the embodiment illustrated in FIG. 3, the package 16 is made from a first panel 18 laminated or attached to a second panel 20 for defining the hollow enclosure. Each panel 18 and 20 is made from the laminate of the present disclosure, such as the laminate illustrated in FIG. 2. In the embodiment illustrated in FIG. 3, the metal foil layer 14 faces the item 22 or the hollow enclosure of the package 16. The polymer layer 18, on the other hand, forms the exterior surface of the package.

As shown in FIG. 3, the panel 18 is attached to the panel 20 along the periphery of the package using any suitable means, such as through lamination, thermal bonding, or through the use of an adhesive. In the embodiment illustrated in FIG. 3, the package 16 is made from two panels 18 and 20. Alternatively, the package can be made from a single panel folded over and attached to itself at a periphery.

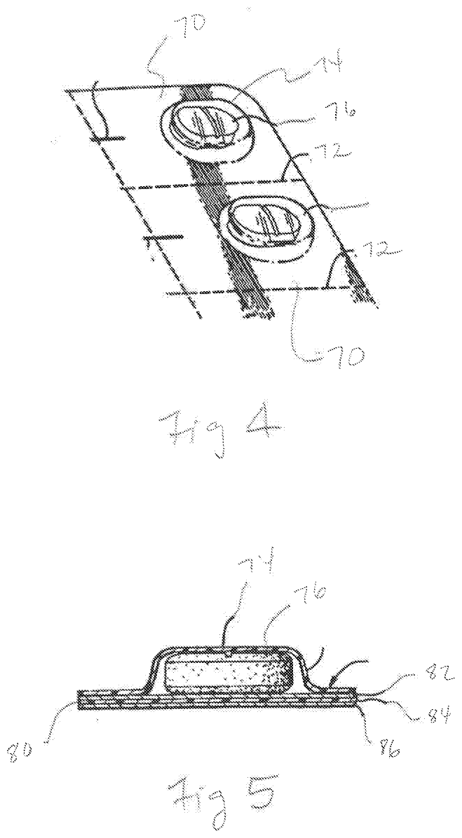

In an alternative embodiment, the laminate of the present disclosure can be used to form a lid or a peel away top for a rigid or semi-rigid container. For example, in one embodiment, the laminate can be used to seal a blister package. Referring to FIGS. 4 and 5, for instance, one embodiment of a blister package 70 made in accordance with the present disclosure is shown. As shown in FIG. 4, a plurality of blister packages 70 can be connected together and can be separated using lines of weakness 72 formed by perforating the package material.

Each blister package 70 includes, in this embodiment, a rigid or semi-rigid thermoformed dome member 74 that defines a hollow enclosure. Within the enclosure is an item 76. The item 76, for instance, may comprise a pill, tablet, or other medication. Alternatively, the item 76 may comprise chewing gum or other food product.

As shown in FIG. 5, the item 76 is held within the hollow enclosure by a panel or laminate 80 that is secured to the dome member 74. Laminate 80 is made in accordance with the present disclosure. For instance, the laminate 80 includes a metal foil layer 82 adhered to a polymer film layer 84 made from the polymer composition of the present disclosure. Optionally, the laminate 80 can include a third layer 86. The third layer 86, for instance, may comprise another polymer layer or can comprise a paper bottom layer.

The laminate 80 is designed to not only seal and preserve the item 76 contained within the blister package 70 but can also be constructed to be rupturable. In particular, a user can push on the item 76 contained within the blister package 70 which will cause the base layer or laminate 80 to rupture for removing the item 76.

In an alternative embodiment, the laminate or base layer 80 can be peelable. In this embodiment, a user can peel away the laminate 80 for gaining access to the item 76.

Similar to the blister package 70, laminates made in accordance with the present disclosure can be used to seal various other thermoformed containers. For instance, the laminate of the present disclosure can be used as a peel away lid on a thermoformed container that contains a food product such as a syrup, a fruit juice, a beverage, a yogurt, or any other liquid or paste.

The laminate of the present disclosure can also be used to produce outdoor panels. For example, in one embodiment, the outdoor panel can generally have the configuration shown in FIG. 2 including a metal panel laminated to a polyethylene layer. The outdoor panel can be used to produce signs, can be used to create decorative panels on buildings, and can be used in all other types of applications. When forming outdoor panels, the metal layer, in one embodiment, can be relatively thick. For instance, the metal layer can have a thickness of greater than about 50 microns, such as greater than about 100 microns, such as greater than about 200 microns, such as greater than about 500 microns, such as greater than about 800 microns, such as greater than about 1000 microns, such as greater than about 1500 microns, such as greater than about 2000 microns, and generally less than about 5000 microns, such as less than about 3000 microns.

The present invention may be better understood with reference to the following examples.

### Test Methods

Melt Flow Index: The melt flow index may be determined in accordance with ASTM D1238-13 at a load of 2.16 kilograms and a temperature of 190° C.

Melting and Glass Transition Temperature: The melting temperature (“Tm”) and glass transition temperature (“Tg”) may be determined by differential scanning calorimetry (“DSC”) in accordance with ASTM D3418-12e1. Under the DSC procedure, samples may be heated and cooled at 20° C. per minute as stated in ISO Standard 10350 using DSC measurements conducted on a TA Q2000 Instrument.

Oxidative Properties: The oxidative properties of a polymer sample can be determined using differential scanning calorimetry (“DSC”) in accordance with ASTM D3895-14. More particularly, a sample may be initially equilibrated under a nitrogen blanket for 2 minutes at 180° C. After equilibration, the atmosphere over the sample may be switched to oxygen. The oxidation process, which is exothermic, may be monitored at 180° C. by measuring the heat flow from the sample. The onset time for oxidation may be determined as the onset of heat flow, and the oxidation process may be followed for an additional 240 minutes. The heat flow measurements may be made as stated in ISO Standard 10350-1:2007 and conducted on a TA Q2000 Instrument.

Peel Strength: The peel strength between a test sample and substrate (e.g., polyester film) may be measured using a 90° T-peel test in accordance with ASTM D1876-08(2015). More particularly, specimens are cut from a T-peel panel to a size of 1 inch×12 inches. The specimen is clamped in the jaws of a tensile tester (e.g., SINTECH™ Tester from MTS Systems). During the test, the force initially increases before reaching a stable level after a peel displacement of two (2) inches. The full test may be completed after six (6) inches of displacement. For each test sample, each sampled force data point collected between displacements of three (3) inches and six (6) inches on five (5) test specimens may be used for analysis. T-Peel strength may be calculated as the average load (grams-force, gf) per inch, as measured during the 90° T-Peel test for (5) samples.

### Control A

ATEVA® 2020 (vinyl acetate=20%, melt index=20 g/min) pellets were extruded into a 50 micron film using a cast film line. The film was then placed between two sheets of aluminum foil and laminated to both sheets. The laminator was set to a temperature of 200° F. and at a pressure of 80 psi. The combined laminate was cut into 15 mm wide strips and each strip was subjected to the peel strength test where the two sheets of foil were separated at a rate of 10 in/min.

### EXAMPLE 1

ATEVA® 2020 (vinyl acetate=20%, melt index=20 g/min) pellets were compounded in a single screw extruder with 0.25 wt. % of BDA masterbatch (Willow Ridge Plastics), which contains a transition metal stearate at a nominal level of 2 wt. % in ethylene vinyl acetate. A second masterbatch was also added containing an antioxidant. The final amount of antioxidant in the resulting blend was 250 ppm. The antioxidant used was IRGANOX 1076.

The above polymer composition was formed into a 50 micron thick film using the same procedure as described above with respect to Control A. The film was formed into a laminate in which the film was sandwiched between two layers of aluminum foil and the resulting laminate was tested for peel strength using the same procedure as described in Control A.

The following results were obtained:

TABLE 1

| | Min. Peel | Max. Peel | Median Peel |
|---|---|---|---|
| | Strength (gf/in) | Strength (gf/in) | Strength (gf/in) |
| Control A | 80 | 180 | 120 |
| Example 1 | 470 | 1790 | 1200 |

As shown above, the difference in peel strength between the Control and Example 1 was dramatic.

### Control B

LDPE 418 (Celanese EVA Polymers), a low density polyethylene with a melt index of 12.7 g/10 min and a density of 0.917 g/cm³, was cast into a 50 micron thick film and laminated between two layers of aluminum foil using the same procedure as described above with respect to Control A, except the lamination temperature was 250° F. The resulting laminate was tested for peel strength.

### EXAMPLE 2

LDPE 418 (Celanese EVA Polymers), a low density polyethylene with a melt index of 12.7 g/10 min and a density of 0.917 g/cm³, was formed into a masterbatch with 2.5 wt. % PDQ-H (Willow Ridge Plastics) which contains a transition metal stearate at a nominal level of 8 wt. % in linear low density polyethylene. The resulting masterbatch was pelletized and then dry blended at 5 wt. % with additional LDPE 418 polymer and extruded into a film in a manner identical to Control A above to form a 50 micron film. The resulting film was sandwiched between two aluminum foil layers and laminated using the same procedure described with respect to Control B. The resulting laminate was tested for peel strength.

The following results were obtained:

TABLE 2

| | Min. Peel | Max. Peel | Median Peel |
|---|---|---|---|
| | Strength (gf/in) | Strength (gf/in) | Strength (gf/in) |
| Control B | 8 | 60 | 14 |
| Example 2 | 100 | 455 | 220 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A laminate comprising:
a first layer comprising a metal foil, the metal foil having a thickness of from about 5 microns to about 65 microns, the metal foil having a first surface and a second and opposite surface; and
a second layer disposed on the first surface of the metal foil, the second layer comprising at least one olefinic polymer combined with at least one transition metal salt, the transition metal salt being present in the second layer in an amount from about 10 to about 1000 parts per million based on the weight of olefinic polymers contained in the layer, the second layer containing one or more olefinic polymers in an amount greater than about 50% by weight and wherein the second layer is directly adhered to the first surface of the metal foil.

2. A laminate as defined in claim 1, wherein the laminate does not contain an adhesive that attaches the second layer to the first surface of the metal foil.

3. A laminate as defined in claim 1, wherein the median peel strength between the first surface of the metal foil and the second layer is from about 100 gf/in to about 5000 gf/in.

4. A laminate as defined in claim 1, wherein the median peel strength between the first surface of the metal foil and the second layer is greater than 800 gf/in.

5. A laminate as defined in claim 1, wherein the second layer contains a low density polyethylene in an amount greater than 50% by weight and wherein the median peel force between the first surface of the metal foil and the second layer is from about 150 gf/in to about 1000 gf/in.

6. A laminate as defined in claim 1, wherein the metal foil comprises an aluminum foil.

7. A laminate as defined in claim 1, wherein the metal foil comprises a copper foil.

8. A laminate as defined in claim 1, wherein the olefinic polymer includes a low density polyethylene, high density polyethylene, linear low density polyethylene, propylene homopolymer, propylene copolymer, olefin-diene copolymer, ethylene acrylic acid copolymer or a partially neutralized ionomer thereof, ethylene methacrylic acid copolymer or a partially neutralized ionomer thereof, ethylene methylacrylate copolymer, ethylene ethyl acrylate copolymer, ethylene butyl acrylate copolymer, or a combination thereof.

9. A laminate as defined in claim 1, wherein the olefinic polymer includes an ethylene vinyl acetate polymer.

10. A laminate as defined in claim 1, wherein the transition metal salt contains a multi-valent transition metal cation.

11. A laminate as defined in claim 10, wherein the cation is iron, manganese, nickel, copper, cobalt, vanadium, chromium, or a combination thereof.

12. A laminate as defined in claim 1, wherein the transition metal salt contains a carboxylate anion.

13. A laminate as defined in claim 12, wherein the carboxylate anion is derived from a fatty acid.

14. A laminate as defined in claim 12, wherein the fatty acid is lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, or a combination thereof.

15. A laminate as defined in claim 14, wherein the salt is nickel stearate.

16. A laminate as defined in claim 14, wherein the salt is cobalt stearate.

17. A laminate as defined in claim 14, wherein the salt is iron stearate, manganese stearate, or a combination thereof.

18. A laminate as defined in claim 1, wherein the composition contains a mixture of transition metal salts.

19. A laminate as defined in claim 18, wherein the mixture contains an iron salt and a manganese salt.

20. A laminate as defined in claim 1, wherein the composition further contains an antioxidant.

21. A laminate as defined in claim 20, wherein the antioxidant is a sterically hindered phenol.

22. A method for forming the laminate of claim 1, the method comprising extruding a polymer composition containing the at least one olefinic polymer and the at least one transition metal salt through a die to form a molten film and passing the molten film through a nip formed between two rolls, wherein the film contacts the metal foil at the nip.

23. A package comprising:
an interior hollow enclosure surrounded by at least one panel, the panel comprising the laminate defined in claim 1.

24.-28. (canceled)
